(19) United States
(12) Patent Application Publication
(10) Pub. No.: US 2012/0019541 A1
(43) Pub. Date: Jan. 26, 2012

(54) Multi-Primitive System

(75) Inventors: Vineet Goel, Winter Park, FL (US); Ralph C. Taylor, Deland, FL (US); Todd E. Martin, Orlando, FL (US)

(73) Assignee: Advanced Micro Devices, Inc., Synnyvale, CA (US)

(21) Appl. No.: 12/839,965

(22) Filed: Jul. 20, 2010

(51) Int. Cl. G06F 15/80

(52) U.S. Cl. 345/505

(57) ABSTRACT

Disclosed herein is a vertex core. The vertex core includes a grouper module configured to process two or more primitives during one clock period and two or more vertex translators configured to respectively receive the two or more processed primitives in parallel.

### BACKGROUND OF THE INVENTION

1. Field of the Invention

The present invention is generally directed to computing operations performed in a computing system. More particularly, the present invention relates to computing operations performed by a processing unit (e.g., a graphics processing unit (GPU)) in a computing system.

2. Background Art

Display images are made up of thousands of tiny dots, where each dot is one of thousands or millions of colors. These dots are known as picture elements, or “pixels”. Each pixel has multiple attributes associated with it, including a color and a texture which is represented by a numerical value stored in the computer system. A three dimensional (3D) display image, although displayed using a two dimensional (2D) array of pixels, may in fact be created by rendering a plurality of graphical objects.

Examples of graphical objects include points, lines, polygons, and 3D solid objects. Points, lines, and polygons represent rendering primitives (aka “prims”) which are the basis for most rendering instructions. More complex structures, such as 3D objects, are formed from a combination or mesh of such primitives. To display a particular scene, the visible primitives associated with the scene are drawn individually by determining those pixels that fall within the edges of the primitives, and obtaining the attributes of the primitives that correspond to each of those pixels.

The inefficient processing of these primitives reduces system performance in rendering complex scenes, for example, to a display. For example, in most graphics systems, primitives are processed serially, which significantly slows the rendering of complex scenes.

What is needed, therefore, are systems and methods to more efficiently process primitives. What is also needed, therefore, are systems and methods to process multiple primitives simultaneously.

### BRIEF SUMMARY OF EMBODIMENTS OF THE INVENTION

The present invention meets the above-described needs by providing methods, apparatuses, and systems for efficiently processing video data in a processing unit.

For example, an embodiment of the present invention provides a vertex core. The vertex core includes a grouper module configured to process two or more primitives during one clock period and two or more vertex processors configured to respectively receive the two or more processed primitives in parallel.

Conventional graphics systems typically process one primitive per clock, severely limiting their processing capability. Embodiments of the present invention resolve the problem of inefficient rendering of complex objects by increasing the primitive processing rate (prim rate) to at least two primitives per clock. This approach to increasing the prim rate will also correspondingly increase the vertex rate. The inventors have discovered that these combined techniques can enhance overall system performance.

In embodiments of the present invention, the direct memory access (DMA) and grouper functionality is separated from the rest of the vertex grouper tessellator (VGT). A separate primitive grouper (PG) module include, for example, DMA and grouper functionality. The remaining functionality of the VGT (e.g., vertex reuse, pass-through, etc.) is mirrored in two or more separate VGT modules, as discussed in greater detail below. This mirroring enables the creation of multiple identical shader core paths operating in parallel, each path processing one primitive during a single clock period.

Further features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate the present invention and, together with the description, further serve to explain the principles of the invention and to enable a person skilled in the relevant art(s) to make and use the invention.

FIG. 1 is a block diagram illustration of a vertex core constructed in accordance with an embodiment of the present invention;

FIG. 2 is a more detailed illustration of the vertex grouper tessellator (VGT) shown in FIG. 1;

FIG. 3 is an illustration of a representative pixel pattern processed in accordance with embodiments of the present invention and

FIG. 4 is a flowchart of an exemplary method for converting three dimensional objects into two dimensional coordinates within a graphics system.

The features and advantages of the present invention will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION OF EMBODIMENTS OF THE INVENTION

Embodiments of the present invention provide a processing unit that enables the execution of video instructions and applications thereof. In the detailed description that follows, references to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

As noted above, in one embodiment of the present invention, the DMA and grouper functionality is separated from the rest of the vertex grouper tessellator (VGT). A separate primitive grouper (PG) module includes, for example, DMA and grouper functionality. The remaining functionality of the VGT which provide vertex processing—e.g., vertex reuse, pass-through, etc., is mirrored in two or more separate VGT modules. This mirroring enables the creation of multiple identical shader core paths operating in parallel, each path processing one of the primitives during the one clock period. These aspects will be addressed more fully below.

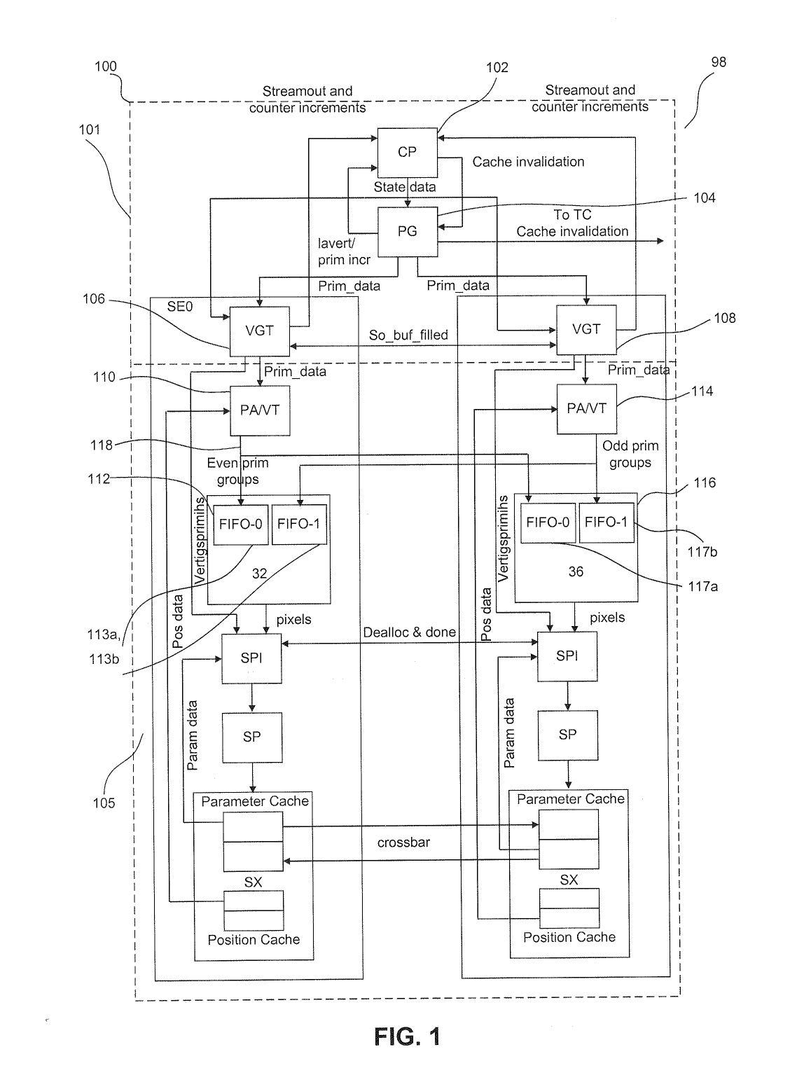

FIG. 1 is a block diagram illustration of an exemplary vertex core 98 constructed in accordance with an embodiment of the present invention. As understood by those of skill in the art, the vertex core 98 assists in converting 3D objects, that exist in virtual space, into 2D coordinates for display on standard screens. In FIG. 1, the exemplary vertex core 98 has a first core section 100 including a command processor (CP) 102, and a second section 101 including a primitive grouper (PG) 104, along with functionally identical VGT modules 106 and 108. The VGT modules 106 and 108 are also included within respective functionally duplicative shader engines SE0 and SE1, as shown.

A third core section 105 includes remaining portions of the shader engines SE0 and SE1. The remaining portion of each shader engine includes, for example, a primitive assembler (PA/VT), and a scan converter (SC), along with other modules such as a shader pipe interpolator (SPI), shader pipe (SP), and shader export buffers (SX).

By way of example, key functions of the PG 104, within the second core section 101, include performing DMA operations on indices, processing immediate data, and performing auto-indexing. These functions are performed on at least two primitives per clock, simultaneously, as will be discussed in greater detail below. The processed primitives are provided, in parallel, as inputs to VGTs 106 and 108, respectively.

In a conventional vertex core, a single VGT includes the combined functionality of the PG 104 and one of the VGTs 106 and 108. In the embodiment of the present invention illustrated in FIG. 1, traditional VGT functionality is spread across three modules: The PG 104, and the VGTs 106 and 108.

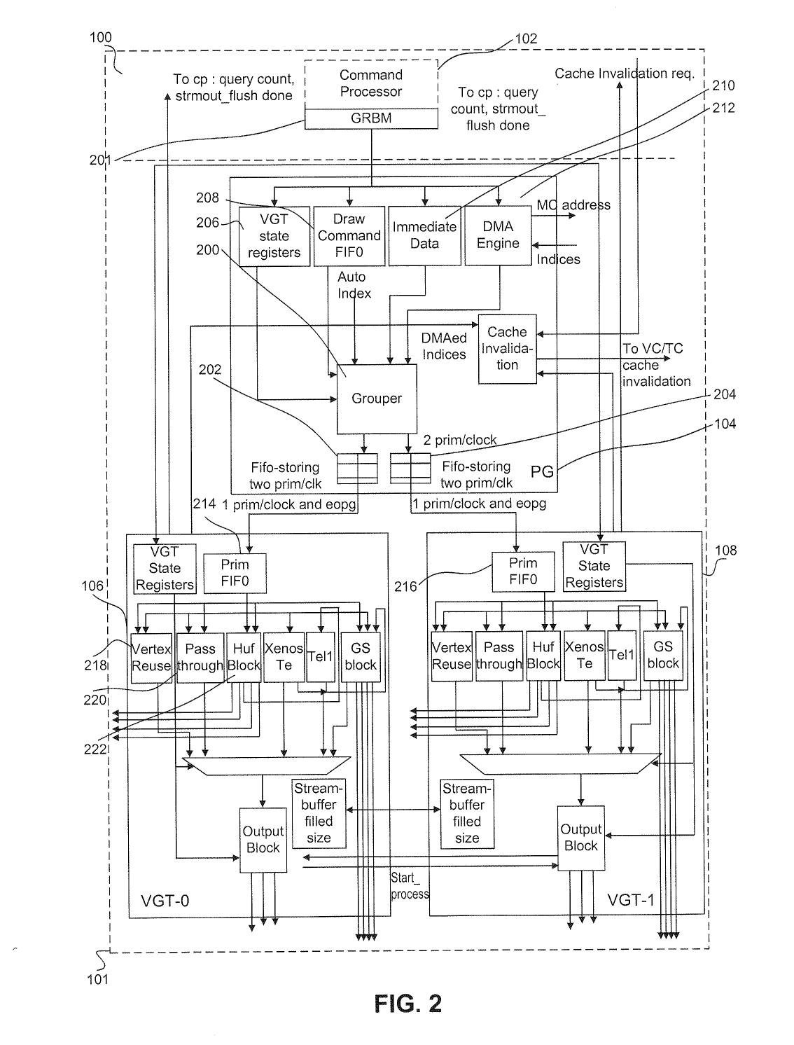

FIG. 2 is a more detailed illustration of the first core section 100 and the second core section 101 of the vertex core 98. The first core section 100 includes the CP 102, which in turn, includes a graphics register bus manager (GRBM) 201. The second core section 101 includes the PG 104 and the VGTs, 106 and 108.

The GRBM 201 sends VGT state register data to the PG 104 and the VGTs 106 and 108. Each of the PG 104, the VGT 106, and the VGT 108 keeps its own set of multi-context registers and single context registers, relevant to its particular function.

The PG 104 is merely one exemplary implementation of a primitive grouper, constructed in accordance with an embodiment of the present invention. The present invention, however, is not limited to this example, as will be appreciated more fully in the discussions that follow.

One of the modules included within the PG 104 is a grouper 200. The grouper 200 is configured to receive and process multiple regular primitives during one clock period, simultaneously. The PG 104 also includes output first-in first-out (FIFO) buffers 202 and 204, VGT state registers 206, and a draw command FIFO 208 for processing draw calls. An immediate data register 210 is provided for processing immediate data and performing auto-indexing. A DMA engine 212 is included for processing DMA indices.

As noted above, the grouper 200, within the second core section 101, plays a key role in enabling the vertex core 98 to process multiple primitives per clock. Since the third section 105 of the vertex core 98 includes only two shader engines SE0 and SE1, vertex core 98 is capable of processing two primitives per clock. Other embodiments of the present invention, however, can include N# of shader engines to process N primitives per clock simultaneously.

By way of example, consider the processing of 200 primitives in the exemplary second core section 101 of FIG. 2. In this example, a first 100 of the 200 primitives will be loaded into the input FIFO 202 and the second 100 primitives will be loaded into the input FIFO 204. More specifically, primitives will be loaded into each of the FIFOs 202 and 204, two at a time for a total of 100 primitives into each FIFO.

The VGTs 106 and 108 include input primitive FIFOs 214 and 216, respectively. In the example above, the primitives are loaded from the output FIFOs 202 and 204 into the input prim FIFOs 214 and 216 one primitive at a time, albeit in parallel. The VGTs 106 and 108 operate completely independently. For a dispatch call, for example, one thread group is sent to one VGT module before switching to a second one. The combined operation of the VGT 106 and the VGT 108 enable the simultaneous independent processing of two primitives per clock. As noted above, however, the present invention is not limited to two primitives per clock. N# of VGT modules, as part of parallel shader engine paths, can be used to receive and process N# of primitives simultaneously.

The VGT 106 (identical to the VGT 108) includes a vertex reuse module 218, a pass-through module 220, and a hull block 222. The grouper 200 indicates which one of the vertex reuse module 218, pass-through module 220, and the hull block 222, etc., will receive the primitive data. This is indicated by storing path information at the output of the grouper 200.

Events and end of packet (eop) go to each of the VGTs 106 and 108, at the end of a packet. More specifically, eop goes to the particular VGT module whose primitive group encounters eop. New packets switch to the other VGT at eop.

Each VGT module (e.g., 106 and 108) retrieves one primitive/clock from its respective primitive input FIFO buffer. Based on the type of processing indicated for the primitive, the primitive is sent to one of the blocks such as vertex reuse module 218, pass-through module 220, the hull block 222, or the tessellation block etc. For all counters, each VGT will have a separate counter interface to the CP 102. Thus, the CP 102 will get counter increment and sample from each of the VGTs.

Referring back to FIG. 1, SE0 also includes PA/VT 110, along with an SC 112. The SC 112 includes internal FIFOs 113a and 113b. Similarly, the SE1 includes PA/VT 114, along with an SC 116. The SC 116 includes internal FIFOs 117a and 117b.

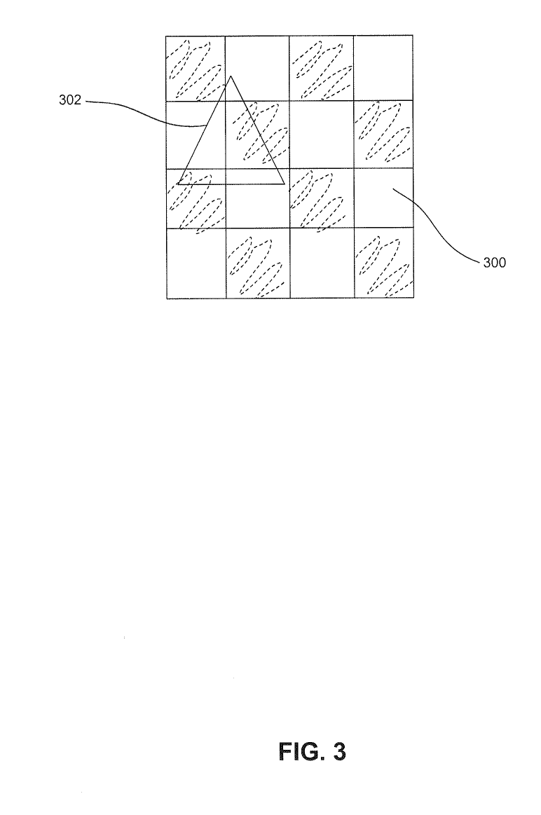

FIG. 3 is an illustration of a representative pixel pattern processed in accordance with embodiments of the present invention. In the “200 primitive” example discussed above, a display screen will be divided into a checkerboard pattern 300. The SC 112 will process the dark areas of the checkerboard pattern 300 and the SC 116 will process the light areas of the checkerboard pattern 300. When the first primitive is processed on the SE0 side (loaded from input primitive FIFO 214), this first primitive might be drawn as triangle 302 in FIG. 3. As shown, some portions of the triangle 302 occur on the light areas of the checkerboard pattern 300, and would therefore be processed by SC 112. Other portions of the triangle 302 occur on the dark areas of the checkerboard pattern 300 and would therefore be processed by the SC 116.

Each primitive loaded on the SE0 side, via the input primitive FIFO 214, will be processed by the SC 112 and the SC 116. For example, the portions of this single primitive that occur over the dark areas of the triangle 302 (see FIG. 3) are routed along a path 118 to FIFO 113a within the SC 112. The portions of this same single primitive (occurring over the light areas of the triangle 302) are also routed along the path 118 to FIFO 117a, within the SC 116.

An identical operation occurs for each of the primitives loaded along the SE1 side. These SE1 primitives are loaded via input primitive FIFO 216. The portions of each of these primitives that occur over the dark areas of the checkerboard pattern 300 are routed to a FIFO 113b within the SC 112. The portions of each of these SE1 side primitives that occur over the light areas of the checkerboard pattern 300 are routed to a FIFO 117b within the SC 116. The SC 116 maintain order by preferably completing the oldest primitive group first. However, maintaining order is not necessary in all cases.

As noted above, the SE0 side and the SE1 side operate independently, but in parallel. In this manner, the vertex core 98, as illustrated in FIGS. 1 and 2, is able to process two primitives per clock. As noted above, however, the present invention is not limited to two primitives per clock. N# of VGT modules can be used to receive and process N# of primitives per clock, simultaneously.

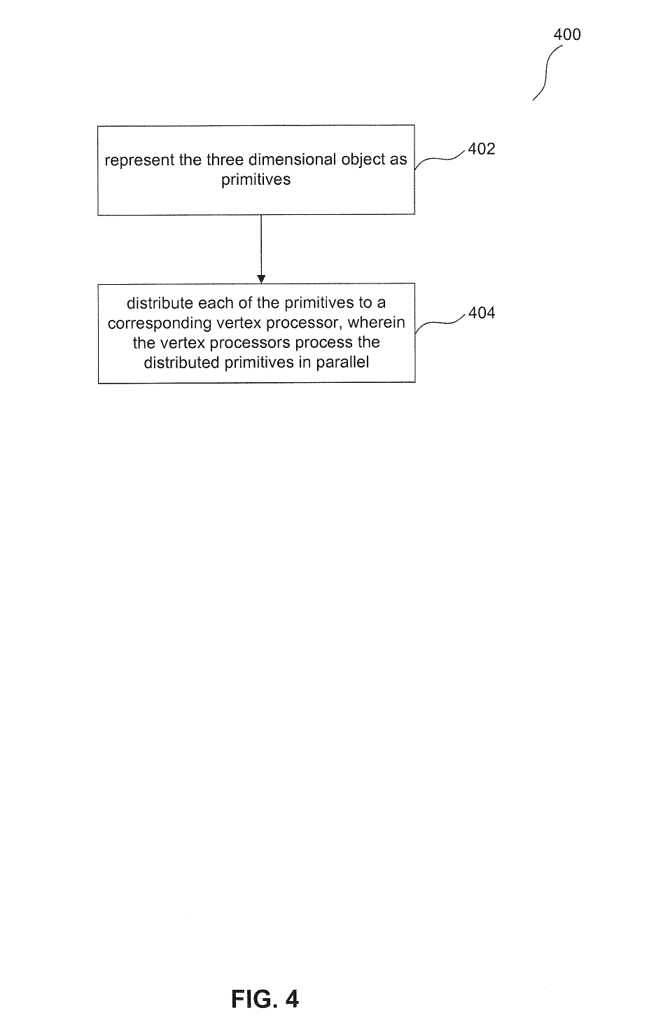

FIG. 4 is a flowchart of an exemplary method 400 for converting three dimensional objects into two dimensional coordinates within a graphics system. In the method 400, a three dimensional object is represented as primitives in step 402. In a step 404, each of the primitives is distributed to a corresponding vertex processor, wherein the vertex processors process the distributed primitives in parallel.

Embodiments of the present invention can be accomplished, for example, through the use of general-programming languages (such as C or C++), hardware-description languages (HDL) including Verilog HDL, VHDL, Altera HDL (AHDL) and so on, or other available programming and/or schematic-capture tools (such as circuit-capture tools). The program code can be disposed in any known computer-readable medium including semiconductor, magnetic disk, or optical disk (such as CD-ROM, DVD-ROM). As such, the code can be transmitted over communication networks including the Internet and internets. It is understood that the functions accomplished and/or structure provided by the systems and techniques described above can be represented in a core (such as a CPU core and/or a GPU core) that is embodied in program code and may be transformed to hardware as part of the production of integrated circuits.

### CONCLUSION

Disclosed above are processing units for processing multiple primitives in a graphics system, and applications thereof. It is to be appreciated that the Detailed Description section, and not the Summary and Abstract sections, is intended to be used to interpret the claims. The Summary and Abstract sections may set forth one or more but not all exemplary embodiments of the present invention as contemplated by the inventor(s), and thus, are not intended to limit the present invention and the appended claims in any way.

What is claimed is:

1. A vertex core comprising:
a grouper module configured to process two or more primitives during one clock period; and
two or more vertex processors configured to respectively receive the two or more processed primitives in parallel.

2. The vertex core of claim 1, wherein the processed primitives are respectively received during the one clock period.

3. The vertex core of claim 2, wherein each vertex processor is configured to perform at least one from the group including vertex reuse, pass through, and tessellation processing.

4. The vertex core of claim 1, wherein the grouper module includes a DMA engine.

5. The vertex core of claim 1, wherein each primitive includes at least two portions, one portion being processed in a first of the vertex processors and the other portion being processed in the second vertex processors.

6. The vertex core of claim 5, wherein the at least two primitive portions are processed in the respective vertex processors in parallel.

7. A method of converting three dimensional objects into two dimensional coordinates within a computer system, comprising:
representing the three dimensional objects as primitives; and
distributing each of the primitives to a corresponding vertex processor within the computer system;
wherein the vertex processors process the distributed primitives in parallel.

8. The method of claim 7, wherein the distributed primitives are processed in parallel during a single clock period.

9. The method of claim 8, wherein each primitive includes multiple portions, each portion being associated with a respective one of the vertex processors.

10. The method of claim 9, wherein the vertex processors process the respective portions in parallel.

11. The method of claim 10, wherein the processing includes at least one from the group including vertex reuse, pass through, and tessellation processing.

12. A vertex core comprising:
a command processor;
a primitive grouper coupled to the command processor; and
at least two shader engines coupled to respective ports of the primitive grouper.

13. The vertex core of claim 12, wherein each shader engine includes a vertex processor.

14. The vertex core of claim 13, wherein each shader engine includes a scan converter coupled, at least indirectly, to the vertex processor.

15. The vertex core of claim 14, wherein the scan converter from one of the shader engines is coupled to the scan converter in the other shader engine.

16. The vertex core of claim 15, wherein the primitive grouper includes direct memory access operations.

17. A computer readable media storing instructions wherein said instructions when executed are adapted to convert three dimensional objects into two dimensional coordinates within a graphics system including multiple vertex processors, with a method comprising:
representing the three dimensional object as primitives; and
distributing each of the primitives to a corresponding one of the vertex processors;
wherein the vertex processors process the distributed primitives in parallel.

18. The computer readable media of claim 17, wherein the distributed primitives are processed in parallel during a single clock period.

19. The computer readable media of claim 18, wherein each primitive includes multiple portions, each portion being associated with a respective one of the vertex processors.

20. The computer readable media of claim 19, wherein the vertex processors process the respective portions in parallel.

21. The computer readable media of claim 20, wherein the processing includes at least one from the group including vertex reuse, pass through, and tessellation processing.
